(19) United States
(12) Patent Application Publication
(10) Pub. No.: US 2018/0119780 A1
(43) Pub. Date: May 3, 2018

(54) TENSIONING DEVICE COMPRISING A LOCKING ELEMENT FOR A CHAIN DRIVE

(71) Applicant: SCHAEFFLER TECHNOLOGIES AG & CO. KG, Herzogenaurach (DE)

(72) Inventors: Robert HEINEMANN, Fuerth (DE); Patrick WEGE, Nuernberg (DE)

(73) Assignee: SCHAEFFLER TECHNOLOGIES AG & CO. KG, Herzogenaurach (DE)

(21) Appl. No.: 15/570,219

(22) PCT Filed: May 4, 2016
(86) PCT No.: PCT/DE2016/200210

§ 371 Date: Oct. 27, 2017

(30) Foreign Application Priority Data
May 7, 2015 (DE) 10 2015 208 452.3

(51) Int. Cl. F16H 7/08

(52) U.S. Cl. CPC F16H 7/0848; F16H 2007/0812

(57) ABSTRACT

A chain tensioner includes a housing that forms a cylindrical receptacle. A piston is surrounded at least in part by the receptacle. The inner surface of the receptacle axially guides the piston when the piston travels into and out of the housing. The chain tensioner further includes a locking unit which limits the inward travel of the piston. The locking unit includes a stop facing the housing, and a mating stop facing the piston. A locking element establishes a force-transmitting connection between the stop and the mating stop. At a location of the stop facing the housing, the housing axially forms a locking section that is located between the locking element and the piston. The locking section includes at least one recess, allowing the locking element to establish the force-transmitting connection between the stop and the mating stop.

### CROSS-REFERENCE TO RELATED APPLICATIONS

This application is the U.S. National Phase of PCT/DE2016/200210 filed May 4, 2016, which claims priority to DE 102015208452.3 filed, May 7, 2015, the entire disclosures of which are incorporated by reference herein.

### TECHNICAL FIELD

This disclosure relates to a hydraulic tensioning device for a chain drive of a combustion engine. Generally, chain drives comprise a chain drive sprocket, which is connected with the crankshaft, an output sprocket, which is connected with a camshaft, and a timing chain, which connects the chain drive sprocket with the output sprocket. The drive torque of the crankshaft is transmitted to the camshaft via the pulling side of the timing chain control drive. The timing chain is tensioned at its return side to ensure its function over the duration of the operating period. For this purpose, the timing chain is supplied with a force by means of a tensioning device.

### BACKGROUND

U.S. Pat. No. 7,189,174 B2 shows a chain tensioner, which has a tubular housing with a floor and a notch at one open end, with a piston, which has a plurality of lock notches at the outer circumference and which is installed in the inner circumference of the housing, with a return spring, which supplies the piston with an outward pressing force, with a stop ring, which is installed between the inner circumference of the housing and the outer circumference of the piston, with a ring element, which can glide in axial direction in a guiding groove and with an actuating element for a radial expansion of the ring element, with a first stopper, which limits the backward movement of the stop ring in relation to the housing by fixing the stop ring in the guiding groove, and with a second stopper, which has an inner diameter that is smaller than the outer diameter of the stop ring for limiting the forward movement of the stop ring in relation to the housing, wherein the stop ring is locked in the guiding groove.

It is the object of the present disclosure to provide a lockable chain tensioner for a chain drive of a combustion engine, which has a simplified structural design.

### SUMMARY

Accordingly, the object is achieved by means of a chain tensioner comprising a housing that forms a cylindrical receptacle, and a piston that is surrounded at least in part by the cylindrical receptacle; the inner lateral surface of the cylindrical receptacle axially guides the piston when the piston travels into and out of the housing. The chain tensioner further comprises a locking unit, which limits the inward travel of the piston; said locking unit includes a stop facing the housing, a mating stop facing the piston, and a locking element that is suitable to establish a force-transmitting connection between the stop facing the housing and the mating stop facing the piston. In the position of the stop facing the housing, the housing axially forms a locking section that is located between the locking element and the piston; said locking section includes at least one recess, thus allowing the locking element to establish the force-transmitting connection between the stop facing the housing and the mating stop facing the piston.

According to the disclosure, the mountability of a lockable chain tensioner can be considerably simplified by designing the locking ring in the form of an external component: along the circumference, the locking element is not arranged in any circumferential section between the axially extending locking section of the housing and the piston. For example, the locking element designed in the form of a locking ring can be mounted in the housing after the piston is connected. Furthermore, the structural design can be simplified because the groove arranged at the inner circumference of the housing, in which the locking ring known from prior art is arranged, is not required. However, above all there are advantages regarding the maintenance of the chain tensioner, because the operating mode can be performed without disassembling the chain tensioner.

The locking element can have an annular section. In particular, the locking element can engage in grooves, which are arranged in circumferential and axially offset manner at the outer circumferential surface of the piston. In particular, the grooves can have a conical profile; the relatively steep groove wall forms the mating stop facing the piston.

In an advantageous further development, the initially one recess of the locking section is axially limited, on the one hand, by the stop facing the housing and, on the other hand, by the mating stop facing the piston.

In a further advantageous embodiment, the locking element meets the end stop when the piston travels out of the housing, whereby the end stop limits the outward travel of the locking element. As a result, the locking element sits on the piston in relatively movable manner; the end stop alone limits an outward travel of the locking element. However, the end stop has no effect on the relative mobility of the piston in relation to the housing.

In a further advantageous embodiment, the end stop limits an outward travel of the locking element, thus allowing for a relative movement between locking element and piston. In a constructively uncomplicated manner, the locking element is displaced in relation to the piston. In particular, the locking element can be moved into an adjacent groove.

In a further advantageous embodiment, the end stop is formed by a ring, which is arranged in an internal or external groove of the locking section. As a result, it is possible to establish an end stop in a constructively uncomplicated manner.

In a further advantageous embodiment, the locking section has at least two recesses. Thus, it is possible to improve, on the one hand, the force-transmitting connection between the stop facing the housing and the locking element and, on the other hand, between the locking element and the mating stop facing the piston. A further improvement is achieved by providing the locking section with at least three recesses.

In a further advantageous embodiment, the locking element involves a locking wire with at least two sections in the form of segments of a circle, which include one radial form; the sections in the form of segments of a circle are arranged in the area of the recesses of the locking section and can be brought in contact with the piston. As a result, it is possible to provide a locking element that can be manufactured in cost-effective manner and that performs the required function. A further improvement is achieved when the locking element is a locking wire provided with at least three sections in the form of segments of a circle, which include two radial forms; the sections in the form of segments of a circle are arranged in the area of the recesses of the locking section and can be brought in contact with the piston.

Furthermore, the problem is solved by a chain tensioner comprising a piston, which is guided in a receptacle and which has locking grooves at its outer circumferential surface, and comprising a locking element, which has at least two annular sections and at least two radial expansions; the locking element can be engaged with one of the locking grooves by means of the at least two annular sections, and comprising a clamping stop and a gliding stop, which are axially spaced from one another, characterized in that the receptacle comprises at least two axial extensions, which extend in axial direction between the clamping stop plane and the gliding stop plane, and that the at least two axial extensions and the piston do not include the two radial expansions. In an advantageous manner, the structural design and mountability of a lockable chain tensioner can be considerably simplified when the locking ring forms a radially external component. The embodiment can be combined with the further developments described above.

The clamping stop can be arranged in an inclined manner in relation to the plane that extends orthogonally to a plane containing the longitudinal axis of the receptacle. Thus, the clamping stop plane involves a plane, which basically includes the linear contact area between clamping stop and locking element. As a result, the clamping stop plane can also extend orthogonally to the plane containing the longitudinal axis of the receptacle. The clamping stop can involve a chamfer, which extends along a portion of the circumference of the receptacle.

In one embodiment, the hydraulic tensioning device is used in a chain drive for a combustion engine comprising a chain drive sprocket, an output sprocket and a timing chain; the timing chain connects the chain drive sprocket and the output sprocket, and the timing chain is tensioned by means of a tensioning device according to any one of the preceding claims.

### BRIEF DESCRIPTION OF THE DRAWINGS

Embodiments of the invention are now described in more detail by means of the embodiments with reference to the drawings. Functionally equivalent elements of the described embodiments are provided with the same reference numerals.

FIG. 1 shows a cross section of an embodiment of the chain tensioner;

FIG. 2 shows a perspective view of the housing; and

FIG. 3 shows a generic chain tensioner from prior art.

### DETAILED DESCRIPTION

FIG. 1 shows a longitudinal section view of a hydraulic tensioning device 1 for a chain drive of a combustion engine. A chain drive comprises a chain drive sprocket, which is connected with the crankshaft, an output sprocket, which is connected with a camshaft, and a timing chain, which connects the chain drive sprocket with the output sprocket (not shown). The drive torque of the crankshaft is transmitted to the camshaft via the pulling side of the timing chain control drive. The timing chain is tensioned at its return side to ensure its function over the duration of the operating period. For this purpose, the timing chain is supplied with a tension force by means of the tensioning device.

The hydraulic tensioning device 1 comprises a housing 2 and a clamping piston (not shown), which can be axially moved in a mounting hole 4 of the housing 2. The piston 3 is provided with a piston cavity, which forms a pressure chamber together with the mounting hole of the housing. A recess is arranged at the end of the housing 2, which is located opposite of the opening for the receptacle of the piston 3. Hydraulic fluid flows via the recess into the pressure chamber; it is drained via a leakage gap. At the end of the clamping piston, which is located remotely from the housing 2, an additional recess has been arranged. Said recess performs the function of a vent opening. The ends form the inflow-side and ventilation-side end of the tensioning device.

At the inflow-side end of the tensioning device 1, a return valve is arranged inside the pressure chamber. Said return valve releases the hydraulic fluid in flow direction and prevents the fluid from escaping the pressure chamber. At the end of the tensioning device located on the ventilation-side, a pre-assembled venting unit is arranged inside the piston cavity. Together with the tempered inner lateral surface of the clamping piston, the venting unit forms an interference-fit assembly, with the clamping piston being designed in the form of an extruded part.

Such tensioning devices 1 for the chain drive of a combustion engine are used for tensioning the timing chain (not shown) and for damping vibrations in the chain drive. Usually, the hydraulic fluid is provided as motor oil by the general hydraulic fluid cycle.

FIG. 1 shows a chain tensioner comprising a housing 2 that forms a cylindrical receptacle 4, and a piston 3 that is surrounded at least in part by the cylindrical receptacle 4. The inner lateral surface of the cylindrical receptacle 4 axially guides the piston when the piston travels into and out of the housing. Furthermore, FIG. 1 shows a locking unit, which limits the inward travel of the piston 3; said locking unit includes a stop 5 facing the housing and a mating stop 6 facing the piston, and a locking element 7 designed in the form of a locking wire. Said locking element 7 is suitable to establish a force-transmitting connection between the stop 5 facing the housing and the mating stop 6 facing the piston. In the position of the stop 5 facing the housing, the housing axially forms a locking section that is formed by three bars 10 distributed along the circumference. The bars are arranged in radial direction between the locking element 7 and the piston 3; said locking section comprises three recesses 11, thus allowing the locking element 7 to establish the force-transmitting connection between the stop 5 facing the housing and the mating stop 6 facing the piston.

The locking wire 7a comprises three sections 12 in the form of segments of a circle, and two radial expansions 13; the sections 12 in the form of segments of a circle are arranged in the area of the recesses 11 of the locking section and can be brought in contact with the piston 3.

Therefore, the chain tensioner 1 comprises a piston 3, which is guided in a receptacle 4 and which has locking grooves (not shown) at its outer circumferential surface, and comprises a locking element 7, which has three annular sections 12 and three radial expansions 13. The locking element 7 is engaged with one of the locking grooves (not shown) by means of the three annular sections 12. Furthermore, the chain tensioner 1 comprises clamping stop 17 and a gliding stop 14, which are axially spaced from one another. The receptacle comprises three axial extensions 10, which extend in axial direction between the clamping stop plane 15 and the gliding stop plane 16. The three axial extensions 10 and the piston 3 do not include the three radial expansions 12. In this way, it can be ensured that the locking element 7 involves the external component, which facilitates the mounting process.

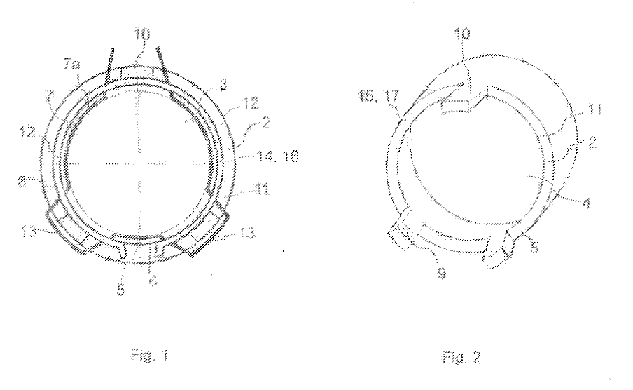

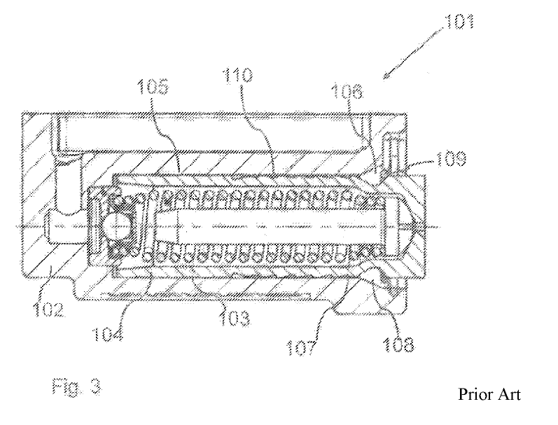

FIG. 2 shows the housing with bars 10, each of which comprises an internal groove 9 for receiving a retaining ring 8. The clamping piston is located inside the housing. The stop 5 facing the housing is also shown.

FIG. 3 shows a chain tensioner 101 that has been disclosed in prior art. The chain tensioner 101 comprises a housing 102 that forms a cylindrical receptacle 103, and a piston 104 that is surrounded at least in part by the cylindrical receptacle 103. The inner lateral surface 105 of the cylindrical receptacle 104 axially guides the piston 103 when said piston travels into the housing 102 and out of the housing 102. A locking unit limits the inward travel of the piston 104; said locking unit includes a stop 106 facing the housing and a mating stop 107 facing the piston, and a locking element in the form of a locking ring 109 arranged in a circumferential groove 108 at the inner circumference of the housing 102. Grooves 110 are arranged in circumferential and axially offset manner at the outer circumferential surface of the piston 104; the locking ring 109 can be brought in contact with each groove 110. The grooves 110 are designed geometrically in such a way that the locking ring 109 can establish a force-transmitting connection between the stop 106 facing the housing and the mating stop 107 facing the piston, thus preventing the inward travel of the piston 103.

### REFERENCE LIST

1 chain tensioner
2 housing
3 piston
4 receptacle
5 stop facing the housing
6 mating stop
7 locking element
8 retaining ring
9 internal groove
10 bar
11 recesses
12 section in the form of a segment of a circle, annular section
13 radial expansion
14 gliding stop
15 clamping stop plane
16 gliding stop plane
17 clamping stop
101 chain tensioner
102 housing
103 piston
104 receptacle
105 inner lateral surface
106 stop facing the housing
107 mating stop facing the piston
108 groove
109 locking ring
110 groove

1. A chain tensioner for an engine, comprising:
a housing defining a cylindrical receptacle having an inner lateral surface; and
a piston surrounded at least in part by the cylindrical receptacle, wherein the inner lateral surface of the cylindrical receptacle axially guides the piston when the piston travels in and out of the housing;
a locking unit, which limits the inward travel of the piston, the locking unit including a stop facing the cylindrical receptacle and a mating stop facing the piston; and
a locking element configured to establish a force-transmitting connection between the stop facing the housing and the mating stop facing the piston;
wherein the housing axially forms a locking section at a location of the stop facing the housing, and the locking section is located between the locking element and the piston, and the locking section includes at least one recess, thus allowing the locking element to establish the force-transmitting connection between the stop facing the housing and the mating stop facing the piston.

2. The chain tensioner according to claim 1, wherein the at least one recess of the locking section is axially limited, on the one hand, by the stop facing the housing and, on the other hand, by an end stop.

3. The chain tensioner according to claim 2, wherein the locking element meets the end stop when the piston travels out of the housing, and the end stop limits the outward travel of the locking element.

4. The chain tensioner according to claim 3, wherein the end stop limits the outward travel of the locking element and enables a relative movement between locking element and piston

5. The chain tensioner according to claim 4, characterized in that the end stop is a retaining a ring that is arranged in an internal or external groove of the locking section.

6. The chain tensioner according to claim 1, wherein the locking section has at least two recesses.

7. The chain tensioner according to claim 6, wherein the locking section has at least three recesses.

8. The chain tensioner according to claim 7, wherein the locking element is a locking wire with at least two sections in the form of segments of a circle, which include one radial form, and the sections in the form of segments of a circle are arranged in an area of the recesses of the locking section and can be brought in contact with the piston.

9. The chain tensioner according to claim 7, wherein the locking element is a locking wire with at least three sections in the form of segments of a circle, which include two radial forms, and the sections in the form of segments of a circle are arranged in an area of the recesses of the locking section and can be brought in contact with the piston.

10. A chain tensioner comprising:
a piston guided in a receptacle of a housing and having locking grooves on an outer circumferential surface of the piston;
a locking element having at least two annular sections and at least two radial expanded sections, the locking element engageable with one of the locking grooves via the at least two annular sections; and
a clamping stop and a gliding stop axially spaced from one another;
wherein the housing includes at least two axial extensions extending in axial direction between a plane of the clamping stop and a plane of the gliding stop, and wherein the at least two axial extensions and the piston do not include the two radial expanded sections.

11. A chain tensioner for an automotive engine, comprising:
a housing having an interior surface extending along an axial direction and defining a cylindrical receptacle, and an axial surface having a plurality of projections extending in the axial direction therefrom;
a piston at least partially surrounded by the cylindrical receptacle, wherein the interior surface of the cylindrical receptacle axially guides axial inward and outward movement of the piston relative to the housing, the piston having an exterior surface defining a plurality of grooves; and
a locking wire having at least two annular sections and at least two radial expanded sections radially outward of the annular sections, wherein the annular sections contact the grooves of the exterior surface of the piston and the radially expanded sections are disposed outboard of the projections of the housing such that the locking wire limits the inward movement of the piston relative to the housing.

12. The chain tensioner of claim 11, wherein the grooves of the exterior surface of the piston define a first stop, the axial surface of the housing defines a second stop, and the locking wire establishes a force-transmitting connection between the first and second stops.

13. The chain tensioner of claim 11, wherein the plurality of projections each define a groove, and a retaining ring is disposed in the grooves.

14. The chain tensioner of claim 13, wherein the locking wire contacts the retaining ring to limit the outward movement of the locking wire to the housing while enabling further outward movement of the piston relative to the housing.
